(19) United States
(12) Patent Application Publication
(10) Pub. No.: US 2010/0248380 A1
(43) Pub. Date: Sep. 30, 2010

(54) METHOD AND ASSAYS FOR QUANTITATION OF ACETAMIDE IN A COMPOSITION

(75) Inventors: Richard D. Gless, JR., Oakland, CA (US); Rebecca Cosford, San Diego, CA (US); Tad Dean, Wilson, NC (US); Michael Horton, Wilson, NC (US); Dean Marbury, Wilson, NC (US); Malcolm Montgomery, Wilson, NC (US); Robert M. Scarborough, (US)

Correspondence Address: Swiss Tanner, P.C.;P.O. Box 1749, Four Main Street, Suite 100, Los Altos, CA, 94022, US

(73) Assignee: Arete Therapeutics, Inc.

(21) Appl. No.: 12/723,250

(22) Filed: Mar. 12, 2010

Related U.S. Application Data
(60) Provisional application No. 61/160,238, filed on Mar. 13, 2009.

(51) Int. Cl. G01N 30/72

(52) U.S. Cl. 436/106

(57) ABSTRACT

Disclosed herein are the methods and assays for quantitative determination of acetamide in a composition of a sample.

### CROSS-REFERENCES TO RELATED APPLICATIONS

This application claims the benefit under 35 U.S.C. 119(e) of U.S. Provisional Application No. 61/160,238 filed Mar. 13, 2009, which is incorporated by reference in its entirety into this application.

### FIELD OF THE INVENTION

Disclosed herein are the methods and assays for quantitative determination of acetamide in a composition of a compound.

### BACKGROUND OF THE INVENTION

The preparation of many compositions that are intended for human or animal use result in the presence of acetamide as an unintended contaminant, e.g. as a reaction side product. In one instance, compositions which are prepared using acetonitrile, e.g., as a solvent or a reagent, are known to produce small amounts of acetamide. Acetamide is also a widely used chemical in the lacquer, cosmetics, explosives, textile, and pharmaceutical industries. It may also be used as a stabilizer in peroxides and as a raw material in organic synthesis (Moretti, T A, Acetic acid derivatives (acetamide) in: Kirkothmer Encyclopedia of Chemical Technology, vol. 1, Wiley, New York, pp. 148-151 (1978)). These products may contain free acetamide, which is considered a potential carcinogenic compound. For example, see Wiles, R. “Case studies of the EPA's application of the Delaney clause in the tolerance-setting process,” Regulating Pesticides in Food: The Delaney Paradox (1987), and Carcinogenic Potency Project (http://potency.berkeley.edu).

The safety of acetamide in acetamide monoethanol amine (MEA) has been assessed by the Cosmetic Ingredient Review (CIR) Expert Panel. Acetamide MEA is an amide made from acetamide and monoethanolamine, also called ethanolamine. In cosmetics and personal care products, acetamide MEA is used in the formulation of bubble baths, hair conditioners, shampoos, wave sets, moisturizers, and other bath and hair care products, as a skin conditioning agent, humectant, surfactant, foam booster, viscosity increasing agent, and antistatic. The CIR Panel evaluation concludes that acetamide may be a minor impurity in Acetamide MEA. The CR Expert Panel has noted that cosmetics and personal care products containing Acetamide MEA should not contain significant amounts of free acetamide.

Acetamide can also be formed through treatment of industrial wastes. For example, nitrile compounds and their derivatives are extensively used in many industrial operations and can be found in industrial waste. A direct discharge of waste water containing some of these nitrile compounds may cause health hazards since nitriles can be toxic, mutagenic, and carcinogenic. Nitriles can be removed from the contaminated streams using biological methods (Manolov, T. et al. “Continuous acetonitrile degradation in a packed-bed bioreactor,” Appl. Microbiol. Biotechnol. 66:567-574 (2005)). When so treated, nitriles can be converted to acetamide as a by-product of such bacterial degradation (DiGeronimo, M. J. et al. “Metabolism of acetonitrile and propionitrile by Nocardia rhodochrous LL100-21,” Appl. Environ. Microbiol. 31:900-906 (1976)).

Various pesticides may be prepared in the form of their acetamide, such as but not limited to, naphthalene pesticides. In evaluating pesticides for re-registration, the Environmental Protection Agency (EPA) obtains and reviews a complete set of studies from pesticide producers that describe the human health and environmental effects of each pesticide. EPA considers the special sensitivity of infants and children to pesticides, as well as aggregate exposure of the public to pesticide residues from all sources, and the cumulative effects of pesticides and other compounds with common mechanisms of toxicity. The Agency develops any mitigation measures or regulatory controls needed to effectively reduce each pesticide's risks. The EPA then re-registers pesticides that meet current human health and safety standards and ensures they can be used without posing unreasonable risks to human health and the environment. High exposure to naphthalene acetamide pesticides have been found to cause side effects in animal models, such as vomiting, stomach lesions, and slight sinusoidal histiocytosis in the livers of males.

Various polymers containing acetamide are also used in preparing products for human use. For example, poly(vinyl acetamide) polymer is prepared from acetaldehyde and acetamide. Poly(vinyl acetamide) polymer-based adhesive composition has been shown as a skin cleansing product (U.S. Pat. No. 6,228,487), and a carbohydrate acetamide composition has been shown as a wound healing product (Wai-Sun et al. “Evaluation of Hyphecan (1-4,2-acetamide-deoxy-B-D-glucan polymer) on wound healing in a rodent model,” Surgical Practice, 6(4), pp. 113-117(5)(2002)).

Acetamide contamination can be difficult to detect in samples. The relatively low volatility and detectability of acetamide can limit usefulness of gas chromatography in detecting very low concentrations. Furthermore, acetamide has low molecular weight that renders it difficult to separate from other low molecular weight contaminants or by-products and lacks any strong UV or IR absorption bands that allow for detection at low levels. See, for example, Olsen et al. “Hydrophilic interaction chromatography using amino and silica columns for the determination of polar pharmaceuticals and impurities,” J. of Chromatography A 913:113-122 (2001); http://www.osha.gov/dts/sltc/methods/partial/t-pv2084-01-8706-ch/t-pv2084-01-8706-ch.html; and Diekmann et al. “Gas Chromatographic-Mass Spectrometric Analysis of Acrylamide and Acetamide in Cigarette Mainstream Smoke after On-Column Injection,” J. of Chromatographic Science 46(7):659-663(5) (2008).

Notwithstanding the adverse effects known to be associated with acetamide contamination, assays accurately measuring the amount of acetamide contamination in chemical or food products or industrial wastes at levels less than 500 ppm have been lacking. Such is undesirable and there is a continuing need to detect or assess a level of acetamide in a given sample.

### SUMMARY OF THE INVENTION

Disclosed herein are the methods and assays for quantitative determination of acetamide in a sample suspected of containing acetamide at levels of less than 500 ppm and preferably less than 250 ppm.

In one aspect of the invention, there is provided a method for assaying detectable amounts of acetamide in a sample suspected of containing the acetamide, the method comprising:

(a) preparing a first composition suitable for chromatographic analysis wherein the first composition comprises the sample and a known detectable amount of acetamide-d₃;

(b) extracting any detectable acetamide together with the known detectable amount of acetamide-d₃ in the first composition by chromatography to provide for a second composition comprising acetamide-d₃ and any detectable acetamide contained in the sample; and

(c) assaying for the presence of the acetamide and the amount thereof, if present, in the second composition by passing a portion of the second composition through a mass spectrometer wherein the presence of the acetamide is confirmed by its molecular ion peak and the amount of the acetamide is determined by a comparison of the intensity of the peak generated by the acetamide to the intensity of the peak generated for the known amount of acetamide-d₃.

In another aspect of the invention, there is provided a method for assaying a detectable amount of acetamide in a sample suspected of containing the acetamide, the method comprising:

(a) preparing a first composition suitable for chromatographic analysis wherein the first composition comprises the sample;

(b) extracting any detectable acetamide in the first composition by chromatography to provide for a second composition comprising any detectable acetamide contained in the sample; and

(c) assaying for the presence of the acetamide and the amount thereof, if present, in the second composition by passing a portion of the second composition through a mass spectrometer, wherein the presence of the acetamide is confirmed by its molecular ion peak and the amount of the acetamide is determined by a comparison of the intensity of that peak to a concentration curve.

In another aspect of the invention, there is provided a method for assaying detectable amount of acetamide in a sample suspected of containing the acetamide, the method comprising:

(a) generating a curve which correlates an intensity of a mass spectrum peak of known concentration of acetamide;

(b) preparing a first composition suitable for chromatographic analysis wherein the first composition comprises the sample;

(c) extracting any detectable acetamide in the first composition by chromatography to provide for a second composition comprising any detectable acetamide contained in the sample; and

(d) assaying for the presence of the acetamide and the amount thereof, if present, in the second composition by passing a portion of the second composition through a mass spectrometer, wherein the presence of the acetamide is confirmed by its molecular ion peak and the amount of the acetamide is determined by a comparison of the intensity of that peak to the concentration curve prepared in (a) above.

In yet another aspect of the invention, there is provided a composition comprising a sample suspected of containing an acetamide and a known amount of acetamide-d₃ wherein the acetamide is at a concentration of less than 200 ppm.

### BRIEF DESCRIPTION OF THE FIGURES

This invention will be further described with reference being made to the accompanying drawings.

FIG. 1 is a flow chart illustrating preparation of Standard and Sample solutions of acetamide, acetamide-d₃, and sample preparation.

FIG. 2 is a flow chart illustrating steps involved in an assay method using the Sample and Spike Sample.

FIG. 3 is a chromatogram of a 1.0 μg/g Acetamide Standard.

FIG. 4 is a Calibration Curve for Acetamide Standards (0.5 to 10 μg/g range).

FIG. 5 is a Calibration Curve for Acetamide Standards (0.5 to 50 μg/g range).

FIG. 6 is a chromatogram of an extract of Compound I with Acetamide spiked at 1.0 μg/g for validation of accuracy.

FIG. 7 is a chromatogram of an extract of Compound I with Acetamide spiked at 0.75 μg/g for validation of accuracy.

FIG. 8 is a chromatogram of an extract of Compound I with Acetamide spiked at 1.25 μg/g for validation of accuracy.

FIG. 9 is a chromatogram of Compound I extract spiked with Acetamide-d₃ Internal Standard.

FIG. 10 is a chromatogram of an extract of Compound I only (endogenous control without Internal Standard Spike).

FIG. 11 is a chromatogram of a Methanol Method Blank.

### DETAILED DESCRIPTION OF THE INVENTION

Throughout this disclosure, various publications, patents and published patent specifications are referenced by an identifying citation. The disclosures of these publications, patents, and published patent specifications are hereby incorporated by reference in their entirety into the present disclosure to more fully describe the state of the art to which this invention pertains.

As used herein, certain terms have the following defined meanings.

As used in the specification and claims, the singular form “a,” “an,” and “the” include plural references unless the context clearly dictates otherwise.

“Chromatographic analysis” as used herein, means any chromatographic technique known in the art, such as, but not limited to, high performance liquid chromatography (HPLC), liquid chromatography (LC), gas chromatography (GC), mass spectrometry (MS), and ultraviolet (UV) etc.

“Acetamide-d₃” as used herein, means CD₃CONH₂.

“Molecular ion peak” as used herein, means a peak obtained for a molecular ion where one electron has been removed from the molecule. The molecular ion is often given the symbol M⁺. The molecular ion that gets protonated is symbolized as M+1. For example, one protonated molecular ion peak for acetamide is m/z 60 and for acetamide-d₃ is m/z 63.

“Intensity of the peak” as used herein, means the height of the peak or integrated area under the peak in the mass spectrum. “Intensity of the signal” means the height of the signal or integrated area of the signal in the mass spectrum. The term “peak” and “signal” are used interchangeably herein.

The term “about” when used before a numerical designation, e.g., temperature, time, amount, molecular weight, and concentration, including range, indicates approximations which may vary by (+) or (−) 5%, 1%, or 0.1%.

In one aspect of the invention, there is provided a method for assaying detectable amounts of acetamide in a sample suspected of containing the acetamide, the method comprising:

(a) preparing a first composition suitable for chromatographic analysis wherein the first composition comprises the sample and a known detectable amount of acetamide-d₃;

(b) extracting any detectable acetamide together with the known detectable amount of acetamide-d₃ in the first composition by chromatography to provide for a second composition comprising acetamide-d₃ and any detectable acetamide contained in the sample; and

(c) assaying for the presence of the acetamide and the amount thereof, if present, in the second composition by passing a portion of the second composition through a mass spectrometer wherein the presence of the acetamide is confirmed by its molecular ion peak and the amount of the acetamide is determined by a comparison of the intensity of the peak generated by the acetamide to the intensity of the peak generated for the known amount of acetamide-d₃.

In some embodiments, the intensity of the peak of acetamide is the area under the peak that is compared to the intensity of the peak which is the area under the peak generated for the known amount of acetamide-d₃.

In some embodiments, the detectable amount of acetamide in the sample is a concentration of less than about 500 ppm.

A composition of the sample suitable for chromatographic analysis includes any sample that can be subjected to chromatographic analysis. For example, such composition includes a composition of the sample in a solvent. Solvent can be water or an organic solvent known in the art, such as, but not limited to, methanol, ethanol, isopropanol, dichloromethane, etc.

In another aspect of the invention, there is provided method for assaying a detectable amount of acetamide in a sample suspected of containing the acetamide, the method comprising:

(a) preparing a first composition suitable for chromatographic analysis wherein the first composition comprises the sample;

(b) extracting any detectable acetamide in the first composition by chromatography to provide for a second composition comprising any detectable acetamide contained in the sample; and

(c) assaying for the presence of the acetamide and the amount thereof, if present, in the second composition by passing a portion of the second composition through a mass spectrometer, wherein the presence of the acetamide is confirmed by its molecular ion peak and the amount of the acetamide is determined by a comparison of the intensity of that peak to a concentration curve.

In another aspect of the invention, there is provided a method for assaying a detectable amount of acetamide in a sample suspected of containing the acetamide, the method comprising:

(a) generating a curve which correlates an intensity of a mass spectrum peak of known concentration of acetamide;

(b) preparing a first composition suitable for chromatographic analysis wherein the first composition comprises the sample;

(c) extracting any detectable acetamide in the first composition by chromatography to provide for a second composition comprising any detectable acetamide contained in the sample; and

(d) assaying for the presence of the acetamide and the amount thereof, if present, in the second composition by passing a portion of the second composition through a mass spectrometer, wherein the presence of the acetamide is confirmed by its molecular ion peak and the amount of the acetamide is determined by a comparison of the intensity of that peak to the concentration curve prepared in (a) above.

In some embodiments, the curve generated in step (a) above comprises plotting intensity of the peak vs. the concentration of the peak and conducting regression analysis. The regression analysis can be linear regression or non-linear regression analysis.

Without limitation to any theory, it is contemplated that the methods of the invention can be used to detect a level of acetamide in any sample that has a detectable amount of acetamide in the composition. For example, the sample may be a drug molecule, an ingredient in making body care products, such as but not limited to, bubble baths, hair conditioners, shampoos, wave sets, moisturizers, and other bath and hair care products, an ingredient in making baby care products, such as but not limited to, baby bottles, sterilizers, baby bath products, etc., an ingredient in making kids toys, an ingredient in making medical care products such as syringes, ampules, or bottles, etc, an ingredient in making pesticides, or an ingredient in food products, such as butter.

In some embodiments, it is contemplated that the methods of the invention can be used to detect a level of acetamide in waste water.

In some embodiments, it is contemplated that the methods of the invention can be used to prepare a composition with a detectable level of acetamide in the composition.

In some embodiments, it is contemplated that the methods of the invention can be used to detect a level of acetamide in acetamide-monoethanolamine (MEA). As provided above, the Cosmetic Ingredient Review (CM) Expert Panel has concluded that acetamide-MEA that is used in cosmetic and personal care products should not contain significant amounts of free acetamide. Accordingly, the methods of the invention can be used to prepare a composition containing acetamide-MEA with a detectable level of free acetamide. The method of the invention can help determine the safety of using acetamide-MEA in cosmetic and personal care products.

In some embodiments, it is contemplated that the methods of the invention can be used to prepare a composition of a pesticide with a detectable level of acetamide. The method of the invention can help determine the safety standard of the pesticide.

In some embodiments, it is contemplated that the methods of the invention can be used to prepare a composition of a polymer with a detectable level of acetamide. Without being limited by any theory, the polymer can also be a copolymer. Alternatively, it is contemplated that the methods of the invention can be used to prepare a composition of monomers with a detectable level of acetamide where the monomers are used to prepare various polymers.

In some embodiments, the step of preparing a composition of the sample comprises dissolving the sample in a suitable solvent such that the impurities of the compounds that are not needed in the assay precipitate out. In some embodiments, this step of preparing the composition of the sample further comprises filtering the precipitate out of the composition using filtration techniques known in the art.

In some embodiments, the step of separating any acetamide in the sample together with the known detectable amount of acetamide-d₃ comprises chromatography techniques, such as, but not limited to, high performance liquid chromatography (HPLC). In some embodiments, the chromatography comprises passing the composition through a solid phase extraction (SPE) cartridge before subjecting it to the HPLC. The SPE cartridge substantially removes the impurities from the composition that are not subject to assay.

In some embodiments, the detectable amount of acetamide in the sample is greater than about 10 parts per million (ppm). In some embodiments, the detectable amount of acetamide in the sample is less than about 500 ppm; less than about 400 ppm; less than about 300 ppm; less than about 250 ppm; preferably, less than about 100 ppm; or more preferably, less than about 10 ppm. In some embodiments, the detectable amount of acetamide in the sample is in a range of about 0.01 ppm to about 250 ppm; about 0.01 ppm to about 100 ppm; preferably, about 0.01 ppm to about 50 ppm; or more preferably, about 0.01 ppm to about 10 ppm.

In some embodiments, the step (a) of preparing the composition of the sample comprises:

(i) dissolving a weighed amount of the sample in a measured amount of acetamide-d₃ diluent to prepare a first sample solution; and

(ii) dissolving a weighed amount of the sample in a measured amount of standard preparation to prepare a second sample solution wherein the standard preparation comprises a measured amount of the acetamide solution mixed with a measured amount of the acetamide-d₃ solution.

In one aspect, there is provided a composition comprising a sample suspected of containing an acetamide and a known amount of acetamide-d₃ wherein the acetamide is at a concentration of less than 200 ppm.

In some embodiments, the concentration of the acetamide and the acetamide-d₃ is altered relative to their initial concentration. Alteration includes, increasing the concentration of acetamide by removing the solvent or decreasing the concentration of acetamide by diluting the sample.

In some embodiments, the concentration of the acetamide is from about 0.01 ppm to about 50 ppm in the sample.

In some embodiments, the chromatography in step (b) comprises a solid phase extraction cartridge that results in retention of at least a portion of the first composition in the cartridge while the acetamide is eluted in the second composition.

In some embodiments, the second composition is a solid comprising acetamide. In another embodiment, the second composition is a solution comprising acetamide.

In some embodiments, the step (c) comprises an analysis by HPLC/MS/MS using multiple reaction monitoring (MRM) mode.

In some embodiments, the method of assaying detectable amounts of acetamide in a sample comprises using the regression equation of Example 1 or the equation of Example 2, provided herein, for calculating the acetamide concentration in the sample.

In some embodiments, the MRM mode comprises a monitoring of one or more fragment ions produced by a loss of ammonia from protonated molecular ions of unlabelled acetamide and d₃-labelled acetamide.

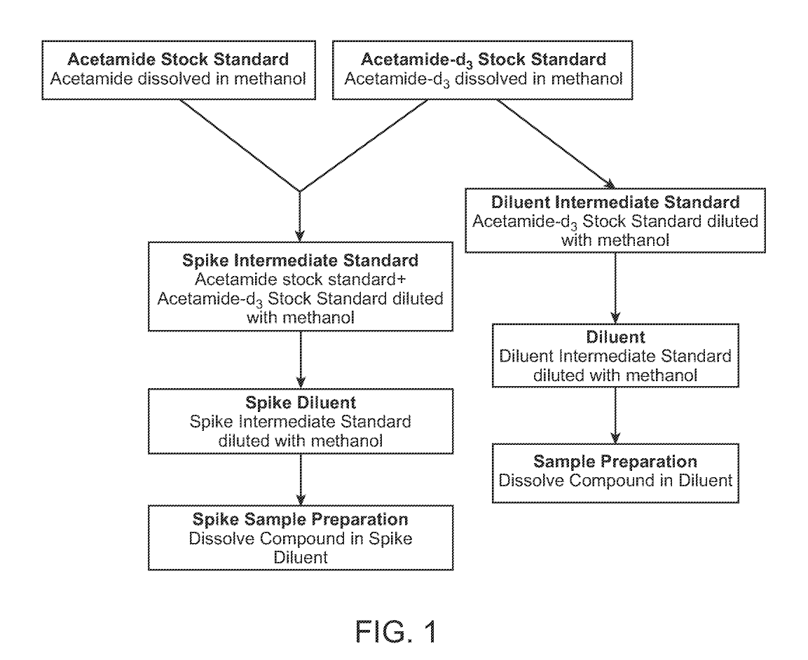

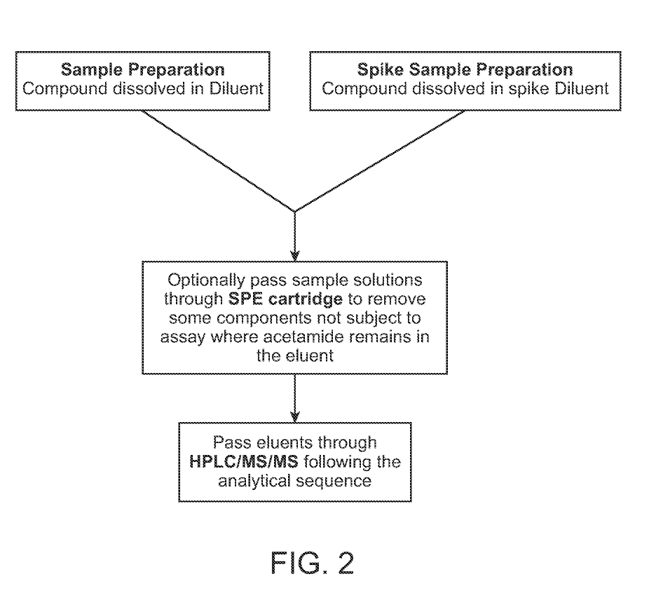

FIGS. 1 and 2 are flow charts that show the various steps that can be involved in the assay method. It is to be understood that depending on the composition of the compound with a detectable amount of acetamide, one or more steps may be altered or removed or the order of the steps may be altered.

FIG. 1 illustrates a method for preparing Standard and Sample solutions of acetamide, acetamide-d₃, and composition of a compound. This flow chart illustrates the solutions prepared as exemplified in Example 1. Example 2 illustrates a different set of solutions that may be prepared in the assay method. It is to be understood that depending on the composition of the compound with a detectable amount of acetamide, the concentration and the volume of the solutions may be altered.

As illustrated in the flow chart of FIG. 1, Acetamide Stock Standard is prepared by dissolving a weighed amount of acetamide in a measured amount of methanol. Acetamide-d₃ Stock Standard is prepared by dissolving a weighed amount of acetamide-d₃ in a measured amount of methanol. Methanol is used as a solvent for illustration purposes only. Any suitable organic solvent may be used in the preparation of the solutions in the assay method, such as but not limited to, ethanol, isopropanol, dichloromethane, carbon tetrachloride, etc., depending on the solubility of the acetamide, the composition to be detected, and/or solubility for the mass spectrometer analysis.

Acetamide Stock Standard and Acetamide-d₃ Stock Standard solutions are then used for preparing intermediate and diluent solutions. Spike Intermediate Standard is prepared by diluting Acetamide Stock Standard and Acetamide-d₃ Stock Standard solutions with methanol. Diluent Intermediate Standard is prepared by diluting Acetamide-d₃ Stock Standard with methanol. Spike Diluent is prepared by diluting Spike Intermediate Standard with methanol. Diluent is prepared by diluting Diluent Intermediate Standard with methanol.

These solutions are then used to prepare Sample solutions and Spike samples. A weighed amount of the compound is dissolved in the Diluent for sample preparation and a weighed amount of the compound is dissolved in the Spike Diluent for the spike sample preparation.

FIG. 2 is a flow chart that shows various steps involved in the assay method using the Sample and the Spike Sample. The Sample and the Spike sample are optionally passed through a solid phase extraction (SPE) cartridge followed by deionized (DI) water. This results in the precipitation of the compound in the cartridge while the acetamide remains in the eluent. The eluent solution is then subjected to high pressure liquid chromatography/mass spectrometry (HPLC/MS/MS) using multiple reaction monitoring (MRM) mode. The MRM mode comprises a monitoring of one or more fragment ions produced by a loss of ammonia from protonated molecular ions of unlabelled acetamide and d₃-labelled acetamide.

Examples herein describe an assay protocol for determining the amount of acetamide in Compound I:

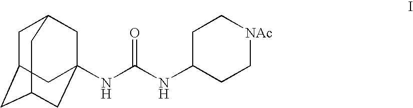

A U.S. Provisional Application 61/160,256 filed Mar. 13, 2009, titled, “Methods and assays for quantitation of acetamide,” is incorporated herein by reference in its entirety. It is to be understood that the assay method described here for Compound I is for illustration purposes only and that the assay method can be used for preparing a composition of any compound that has a detectable amount of acetamide.

The following examples are provided to illustrate certain aspects of the present invention and to aid those of skill in the art in practicing the invention. These examples are in no way to be considered to limit the scope of the invention.

In the examples below as well as throughout the application, the following abbreviations have the following meanings. If not defined, the terms have their generally accepted meanings.

| | |
|---|---|
| API = | active pharmaceutical ingredient |
| Å= | angstrom |
| amu = | atomic mass unit |
| DI = | deionized |
| g = | gram |
| HPLC/MS/MS = | high pressure liquid chromatography/mass |
| | spectroscopy |
| μL = | microliter |
| μg = | microgram |
| mg = | milligram |
| MRM = | multiple reaction monitoring |
| mL = | milliliter |
| m/z = | mass per charge |
| SPE = | solid phase extraction |
| Wt. = | weight |

### EXAMPLE

### Materials and Reagents

The method is described using the following equipment and reagents. However, a person skilled in the art would appreciate that similar or equivalent equipment or reagents can also be used to perform the method of this invention. Additional equipment or reagents may also be used, which may be apparent to a person skilled in the art.

The methods below were used for quantitation of acetamide in an active pharmaceutical ingredient (API), Compound I, to determine concentration at or below 1 μg/g by HPLC/MS/MS using MRM mode. These protocols can validate both the suitable API working range (e.g. ˜0.5-5.0 μg/g) and the full dynamic range (e.g. ˜0.5-50 μg/g).

### Equipment

HPLC/MS/MS System: Applied Biosystems API-5000 (for Example 1) API-3000 (for Example 2) with Shimadzu gradient HPLC system equipped with column heater, or equivalent; HPLC Column: Phenomenex Polar RP® column, 25 cm×2 mm×4 μm particle size, 80 Å pore size. P/N 00G-4336-B0;

Analytical Balance, 0.1 mg sensitivity;

### Assorted Class A Volumetric Flasks;

HPLC Amber Injection Vials (2 mL, glass);

### Teflon/Silicone-Lined Septa Caps;

Class A Pipettes, assorted sizes; and
Solid phase extraction (SPE) Cartridges: Bakerbond Octadecyl (C_{I8}) Cat# 7020-03.

### Reagents/Standards/Solutions

Acetamide, Sigma, Cat# A0500-1 006;

### Methanol, Fisher Optima, Cat# A456-1;

### USP Purified Water, EMD Omni Solv Cat# WX 0004-1; and

Acetamide-d₃, Medical Isotopes, Inc, Cat# D719, Purity 99.3 atom % or equivalent. A lower isotopic purity may be used provided that the method blank is free of interfering acetamide signal for the unlabeled species. The label is for the methylene deuteration sites.

### Example 1

### Determination of Acetamide in Compound I

### HPLC Parameters

The following exemplifies HPLC conditions for separating acetamide contained in a sample and collecting the acetamide containing eluent fractions for mass spectrometry analysis. The volume of the solutions specified in this method for HPLC mobile phases may be adjusted, provided the final solution concentrations remain the same.

### Injection Volume: 10 μL.

HPLC Flow rate: 0.2 mL/min.
Initial mobile phase composition: 80% mobile phase A, 20% mobile phase B.
Mobile phase A: 90:10 water/methanol.
Mobile phase B: 100% methanol.
Column temperature: 55° C.

### Injector Rinse: Methanol

### Gradient/Valve Program for HPLC

| Time (min) | Attribute | Function % |
|---|---|---|
| 0.01 | Pump B Conc. | 20 |
| 3.50 | Pump B Conc. | 20 |
| 5.00 | Rotary Valve A | waste |
| 7.00 | Pump B Conc. | 95 |
| 19.00 | Pump B Conc. | 95 |
| 20.00 | Pump B Conc. | 20 |
| 20.00 | Rotary Valve A | MS |
| 25.0 | Stop | |

### Mass Spectrometer Conditions

The following exemplifies mass spectrometer conditions used in a method of the invention. The values used may vary depending on optimization of the initial instrument tune parameters.

CUR: 50

GS1: 50

GS2: 60

TEM: 450

ihe: ON

IS: 5500

CAD: 5

DP: 55

EP 5

CE: 21

CXP: 19

Scan Type: MRM

Polarity: Positive

Ion Source: Turbo Ion-Spray

Table below is for tuning parameters for the instrument where, for monitoring acetamide peaks are 60.20 and 43.20, and for deutrated acetamide the peaks are 63.20 and 46.20.

| Q1 Mass (amu) | Q3 Mass (amu) | Dwell (msec) |
|---|---|---|
| 60.20 | 43.20 | 150.00 |
| 63.20 | 46.20 | 150.00 |
| 320.20 | 143.10 | 50.00 |

### Mass Spec Collection Time: 6 min.

The exact masses used for Q1 and Q3 may be adjusted within +/−0.2 amu to allow data collection at the experimentally determined mass peak top.

### Standard and Sample Preparations

The following illustrates examples of procedures of how the standard and/or sample solutions are prepared. Suitable variations are apparent to those skilled in the art. All solutions are labeled with an expiration date, unless otherwise noted. All solutions may be stored under ambient conditions, protected from light.

### Standard Preparation:

Acetamide Stock Standard: Approximately 50 mg of acetamide is accurately weighed and is dissolved in 50.0 mL of methanol.

Acetamide-d₃ Stock Standard: Approximately 50 mg acetamide-d₃ is accurately weighed and dissolved in 50.0 mL methanol. This solution is used as the internal standard stock for the diluent and spike solutions.

Spike Intermediate Standard: 0.50 mL Acetamide Stock Standard and 0.50 mL Acetamide-d₃ Stock Standard are transferred into a 50 mL volumetric flask and diluted to volume with methanol.

Diluent Intermediate Standard: 0.50 mL Acetamide-d₃ Stock Standard is transferred into a 50 mL volumetric flask and diluted to volume with methanol.

Spike Diluent: 0.50 mL Spike Intermediate Standard is transferred into a 100 mL volumetric flask and diluted to volume with methanol. Approximate concentrations are 0.050 μg/mL acetamide and 0.050 μg/mL acetamide-d₃.

Diluent: 0.50 mL Diluent Intermediate Standard is transferred into a 100 mL volumetric flask and diluted to volume with methanol. Approximate concentration is 0.050 μg/mL acetamide-d₃.

### Sample Preparation:

Approximately 50 mg of Compound I is weighed accurately into an autosampler vial and dissolved in 1.0 mL Diluent.

### Spike Sample Preparation:

Approximately 50 mg of Compound I is weighed accurately into an autosampler vial and dissolved in 1.0 mL spike Diluent.

### Sample, Standard, and Spike Cleanup

All standards, unspiked samples, spiked samples, and blanks (individually and collectively “sample”) are processed through a solid phase extraction cartridge (SPE) to remove the Compound I as follows:

SPE cartridge is prepared as follows:
About 3 mL methanol is eluted through the SPE column, followed by about 3 mL DI water, and finally about 3 mL of 50/50 methanol/water solution. The column is not allowed to air dry.
To the prepared cartridge, 1.0 mL 50/50 methanol/DI water solution is added and elution is begun until column packing material is coated and the first drop begins to elute. Elution is stopped at this point. If more than ten drops of eluent are expelled, the column is discarded and the elution is begun again.
1.0 mL sample is added and then 1.0 mL cold (˜3-8° C.) DI water is added. This begins precipitation of Compound I while retaining the acetamide in solution.
The contents of the SPE cartridge are eluted dropwise. Elution takes approximately 1 minute to complete. After elution, 1.0 mL 95/5 water/methanol is added to the SPE cartridge and eluted as before. All 4 mL of eluent are collected, an aliquot is transferred to an autosampler vial, and analyzed by HPLC/MS/MS using the conditions/parameters above.

### HPLC/MS/MS Typical Analytical Sequence

The following table provides a typical analytical sequence used for analyzing the eluents from an SPE cartridge:

| Line | Sample | Sample Description | No. of Injections |
|---|---|---|---|
| 1 | 0.050 μg/mL standard | Conditioning injections | At least 2 |
| 2 | Methanol Blank | Blank | At least 1 |
| 3 | 0.050 μg/mL standard | Suitability (Precision) | 6 |
| 4 | 0.025 μg/mL standard | Suitability (Linearity) | 1 |
| 5 | 0.075 μg/mL standard | Suitability (Linearity) | 1 |
| 6 | Method Blank | Suitability | 2 |
| 7 | Sample Extracts | Samples for quantitation | Duplicate injections for |
| | (unspiked and spiked) | | each extract, up to 10 total |
| | | | injections |
| 8 | 0.050 μg/mL standard | Suitability (continuing | 2 |
| | | bracketing standard) | |

Lines 7-8 are repeated until all samples are analyzed.

### Data and Calculations

Preferably, the methanol blank is free of interferences for both the acetamide and internal standard at their respective retention time windows as established, for example, by the 0.050 μg/mL standard, or as determined in validation. The internal standard is present at least 10:1 S:N or as determined in validation.

### Limit of Quantitation (LOQ)

The signal for acetamide is NLT10:1 S:N or as determined in validation of the method.

Quantitation of acetamide is performed by integration of the m/z 60.2/43.2 signal (unlabeled acetamide) and the m/z 63.0/46.2 signal (acetamide-d₃). The response ratio (AR), which is the ratio of the intensities of the acetamide/acetamide-d₃ peak areas thus determined, is calculated and regressed against the concentration ratio of the acetamide/acetamide-d₃ concentrations for each standard. The regression equation thus obtained (calibration curve) is used to calculate concentrations of acetamide in sample injections as follows:

Area Ratios (AR) are determined for all samples, standards, and blanks, as applicable:

The peak areas for acetamide and acetamide-d₃ are integrated. The area ratios are calculated by dividing the area of the acetamide by the area of the acetamide-d₃:

AR=Area_{acetamide}/Area_{acetamide-d3}

The calibration curve is determined for standards as follows:

Using the last injection of the 0.050 μg/mL standard from precision, and the 0.025 μg/mL standard and 0.075 μg/g standards, the linear regression parameters of slope and y-intercept and coefficient of determination, r² are calculated.

AR=SLOPE[Conc. Standard (μg/g)]−INT

where:
SLOPE=slope from regression equation;
INT=y-intercept from regression equation; and
r²=correlation coefficient.

Acetamide concentration in sample extract can be calculated as follows:

Sample Conc. μg/mL=[(Aₛₐₘₚₗₑ/A_{IS})−INT]*[(IS Conc. μg/mL)/SLOPE]

where:
Sample Conc. μg/mL=concentration of acetamide in sample extract, μg/mL;
Aₛₐₘₚₗₑ/A_{IS}=[area of acetamide]/[area of acetamide-d₃] in sample extract;
INT=y-intercept from regression equation;
IS Conc. μg/mL=concentration of acetamide-d₃ in sample extract, μg/mL; and
SLOPE=slope from regression equation.

The gravimetric concentration of acetamide in samples can be calculated using the equation:

Sample Conc. μg/g=(Sample Conc. μg/mL*1.0 mL)/(Sample wt(g))

where:
Sample Conc. μg/g=gravimetric sample concentration, μg/g;
1.0 mL=volume of sample extract, mL; and
Sample wt.=weight of sample, g

For recovery calculations, the % recovery of acetamide spiked into Compound I is calculated using the equation:

% Recovery=[(Experimental Conc.)/Theoretical Conc.]*100.

where:
Experimental Conc.=Analytically determined concentration of acetamide in drug, μg/g; and
Theoretical Conc.=Concentration of acetamide calculated to have been spiked,

### Example 2

### Determination of Acetamide in Compound I

### HPLC Parameters

The following exemplifies HPLC conditions for separating acetamide contained in a sample and collecting the acetamide containing eluent fractions for mass spectrometry analysis. The volume of the solutions specified in this method for HPLC mobile phases may be adjusted, provided the final solution concentrations remain the same.

### Injection Volume: 10 μL.

HPLC Flow rate: 0.2 mL/min.
Mobile phase A: Add 900 mL of DI water to 100 mL of methanol and mix.
Mobile phase B: methanol.
95/5 water methanol solution: Add 95 mL of DI water to 5 mL of methanol and mix.
50/50 water methanol solution: Add 50 mL of DI water to 50 mL of methanol and mix.
Cold DI water: Add DI water to a 125 mL Erlenmeyer flask and place in an ice bath for a minimum of 10 to 15 minutes.
Column temperature: 55° C.

### Injector Rinse: Methanol

### Gradient/Valve Program for HPLC

| Time (min) | Attribute | Function % |
|---|---|---|
| 0.0 | MP B | 20 |
| 3.5 | MP B | 20 |
| 5.0 | Rotary Valve A | waste |
| 7.0 | MP B Conc. | 95 |
| 19.0 | MP B Conc. | 95 |
| 20.0 | MP B Conc. | 20 |
| 20.0 | Rotary Valve A | MS |
| 25.0 | Stop Run | — |

### Mass Spectrometer Conditions

The following exemplifies mass spectrometer conditions used in the method of the invention. The values used may vary depending on optimization of the initial instrument tune parameters.

Scan Type: MRM

Polarity: Positive

Ion Source: Turbo Ion-Spray

| Q1 Mass (amu) | Q3 Mass (amu) | Dwell (msec) |
|---|---|---|
| 60.20 | 43.20 | 150.00 |
| 63.20 | 46.20 | 150.00 |
| 320.20 | 143.10 | 50.00 |

### Mass Spec Collection Time: 5 min.

The exact masses used for Q1 and Q3 may be adjusted within +/−0.2 amu to allow data collection at the experimentally determined mass peak top.

### Standard and Sample Preparations

The following illustrates examples of procedures of how the standard and/or sample solutions are prepared. Suitable variations are apparent to those skilled in the art. All solutions may be labeled with an expiration date, unless otherwise noted. All solutions may be stored under ambient conditions, protected from light.

### Standard Preparation:

Acetamide Stock Standard: Approximately 50 mg of acetamide is accurately weighed and dissolved in 100.0 mL of methanol.

Acetamide-d₃ Stock Standard: Approximately 50 mg acetamide-d₃ is accurately weighed and dissolved in 100.0 mL methanol. This solution is used as the internal standard stock for the diluent and spike solutions.

Acetamide Intermediate Standard: 0.50 mL Acetamide Stock Standard is transferred into a 50 mL volumetric flask and diluted to volume with methanol.

Acetamide-d₃ Intermediate Standard: 0.50 mL Acetamide-d₃ Stock Standard is transferred into a 50 mL volumetric flask and diluted to volume with methanol.

0.5 μg/g Standard Preparation: 0.25 mL Acetamide Intermediate Standard and 0.50 mL Acetamide-d₃ Intermediate Standard are transferred into a 50 mL volumetric flask and diluted to volume with methanol.

1.0 μg/g Standard Preparation: 0.50 mL Acetamide Intermediate Standard and 0.50 mL Acetamide-d₃ Intermediate Standard are transferred into a 50 mL volumetric flask and diluted to volume with methanol.

1.5 μg/g Standard Preparation: 0.75 mL Acetamide Intermediate Standard and 0.50 mL Acetamide-d₃ Intermediate Standard are transferred into a 50 mL volumetric flask and diluted to volume with methanol.

Acetamide-d₃ Diluent: 0.50 mL Acetamide-d₃ Intermediate Standard is transferred into a 50 mL volumetric flask and diluted to volume with methanol. Approximate concentration is 0.050 μg/mL acetamide-d₃.

The standard solutions are stable at 2-8° C. for at least about seven days.

Sample Preparation: Approximately 50 mg of Compound I is accurately weighed into an 4 mL autosampler vial and dissolved in 1.0 mL of Acetamide-d₃ diluent.
Spike Sample Preparation: Approximately 50 mg of Compound I is accurately weighed into an 4 mL autosampler vial and dissolved it in 1.0 mL of 1.0 μg/g Standard Preparation.

### Sample, Standard, and Spike Cleanup

All standards, unspiked samples, spiked samples, and blanks (individually and collectively “sample”) are processed through a solid phase extraction cartridge (SPE) to remove Compound I as follows:

SPE cartridge is prepared as follows:
About 3 mL methanol is eluted through the SPE column, followed by about 3 mL DI water and finally about 3 mL of 50/50 methanol/water solution. The column is not allowed to air dry.
To the prepared cartridge, 1.0 mL 50/50 methanol/DI water solution is added and elution is begun until column packing material is coated and first drop begins to elute. Elution is stopped at this point. If more than ten drops of eluent are expelled, the column is discarded and begun again.
1.0 mL sample is added and then 1.0 mL cold DI water is added. This begins precipitation of Compound I while retaining the acetamide in solution.
Contents of SPE cartridge are eluted dropwise. Elution takes approximately 1 minute to complete. After elution, 1.0 mL 95/5 water/methanol is added to the SPE cartridge and eluted as before. All 4 mL of eluent are collected, an aliquot is transferred to an autosampler vial, and analyzed by HPLC/MS/MS using the conditions/parameters above.
Once the SPE cartridge clean up has been performed, the sample and standard solutions are stable at 2-8° C. for at least seven days.

### HPLC/MS/MS Typical Analytical Sequence

The following table provides a typical analytical sequence used for analyzing the eluents from an SPE cartridge:

| Line | Sample | Sample Description | No. of Injections |
|---|---|---|---|
| 1 | 1.0 μg/g standard | Conditioning injections | At least 2 |
| 2 | Methanol Blank | Blank | At least 1 |
| 3 | 1.0 μg/g standard | Suitability (Precision) | 6 |
| 4 | 0.5 μg/g standard | Suitability (Linearity) | 1 |
| 5 | 1.5 μg/g standard | Suitability (Linearity) | 1 |
| 6 | Method Blank | Suitability | 2 |
| 7 | Sample Extracts | Samples for quantitation | Duplicate injections for |
| | (unspiked and spiked) | | each extract, up to 10 total |
| | | | injections |
| 8 | 1.0 μg/mL standard | Suitability (continuing | 2 |
| | | bracketing standard) | |

Lines 7-8 are repeated until all samples are analyzed.

### Acetamide Concentration Determination

[Conc.]ₛₐₘ=[(ARₛₐₘₚ)*(1.0 mL)/[RF*Wtₛₐₘₚ]

### Where:

RF=(Avg. AR_{std})/[Conc.]_{std}

Avg.AR_{std}=average of the AR_{std} for the 6 precision standards

AR_{std}=Area_{acetamide}/Area_{acetamide-d3} for the 1 μg/g standard

ARₛₐₘₚ=Area_{acetamide}/Area_{acetamide-d3} for the sample

[Conc.]ₛₐₘ=acetamide concentration of sample extract, (μg/g)

[Conc.]_{std}=acetamide concentration of standard, (μg/mL)

Wtₛₐₘₚ=weight of the sample (g)

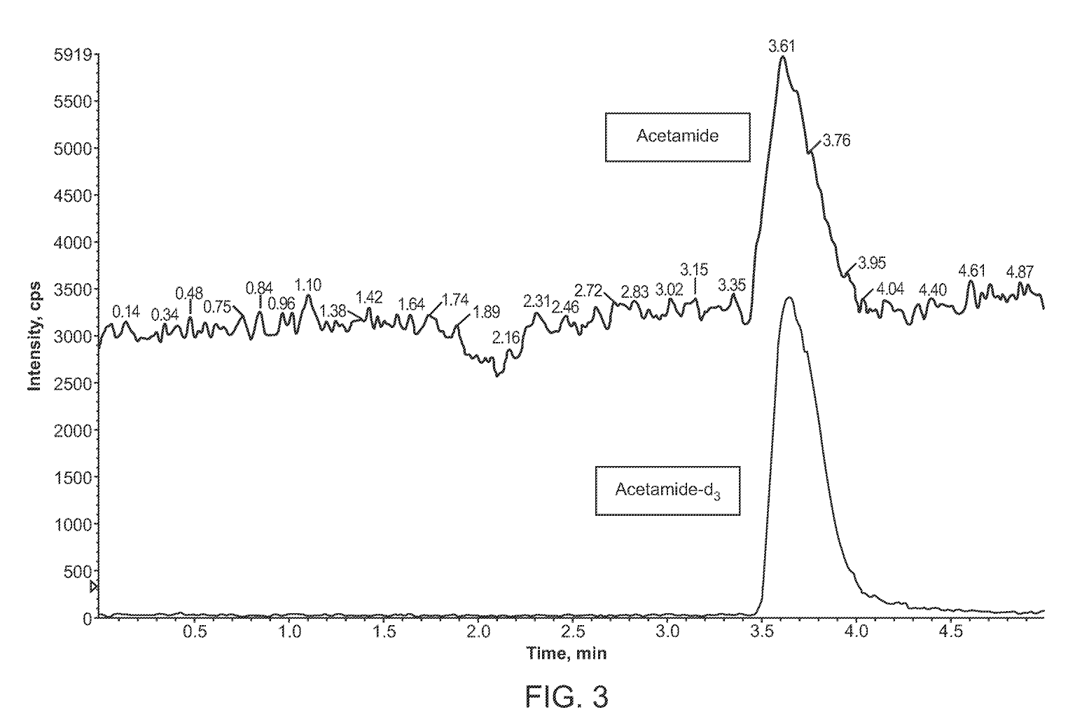

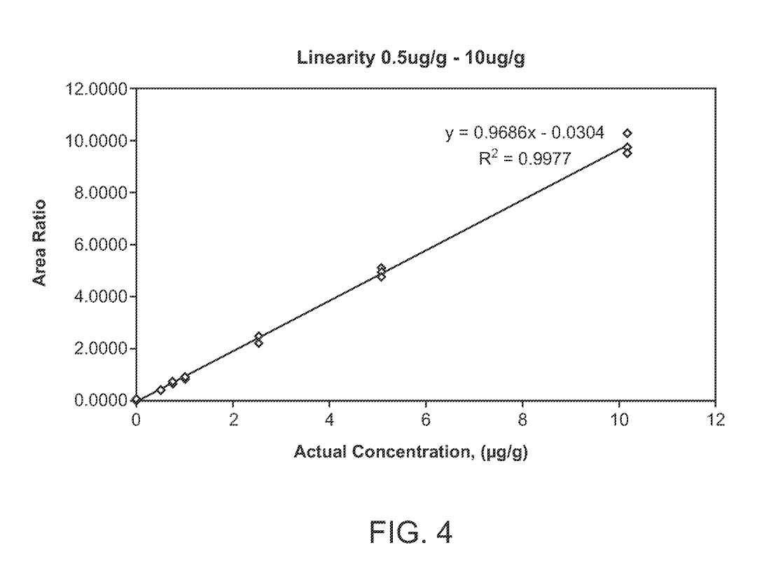

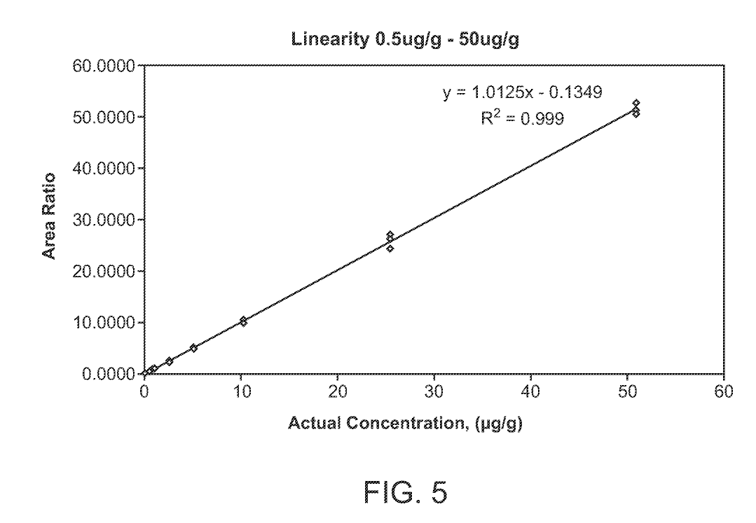

FIG. 3 is a chromatogram of a 1.0 μg/g Acetamide Standard. FIG. 4 is a Calibration Curve for Acetamide Intermediate Standards (0.5 to 10 μg/g range). FIG. 5 is a Calibration Curve for Acetamide Intermediate Standards (0.5 to 50 μg/g range).

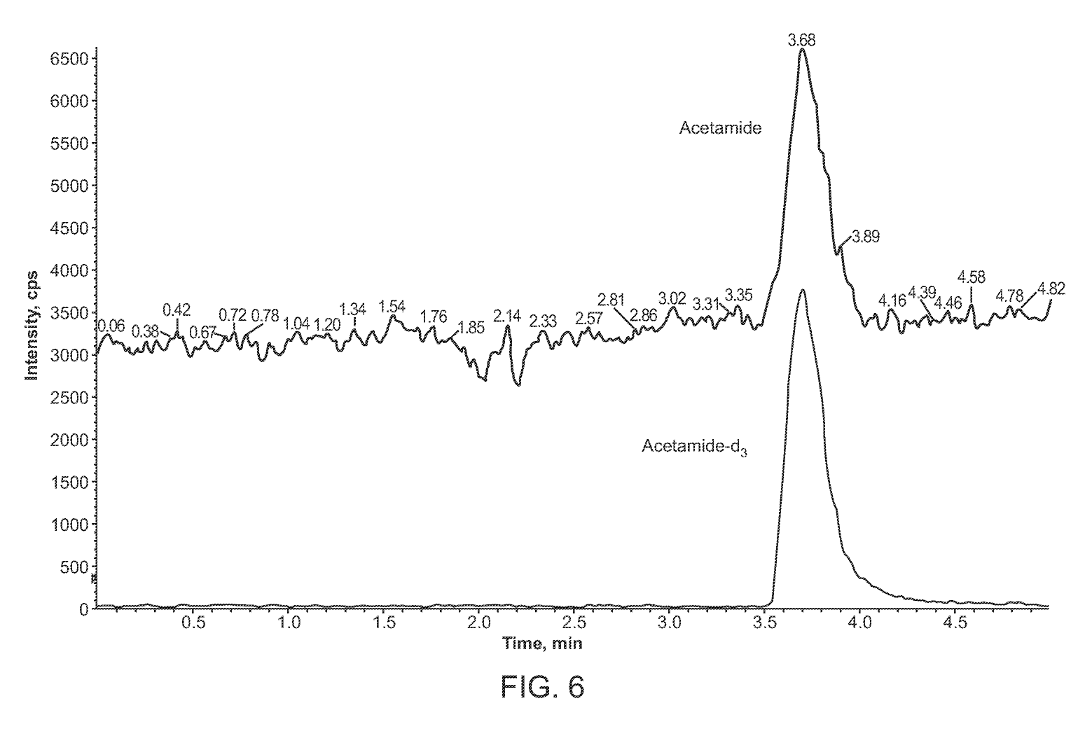

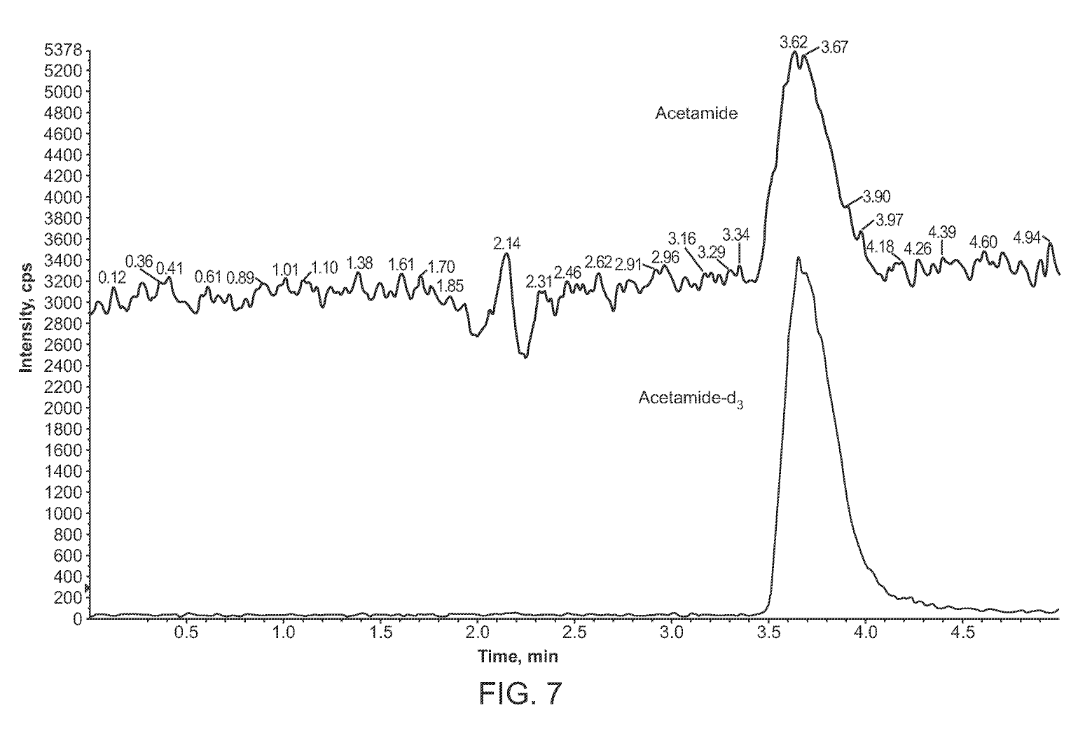

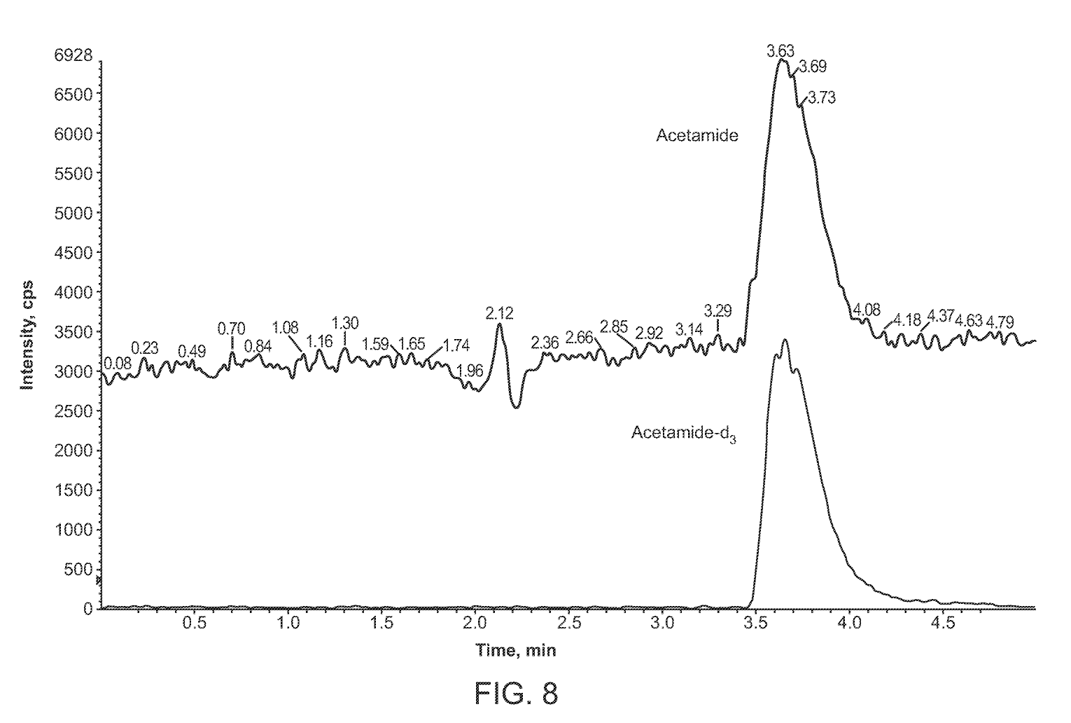

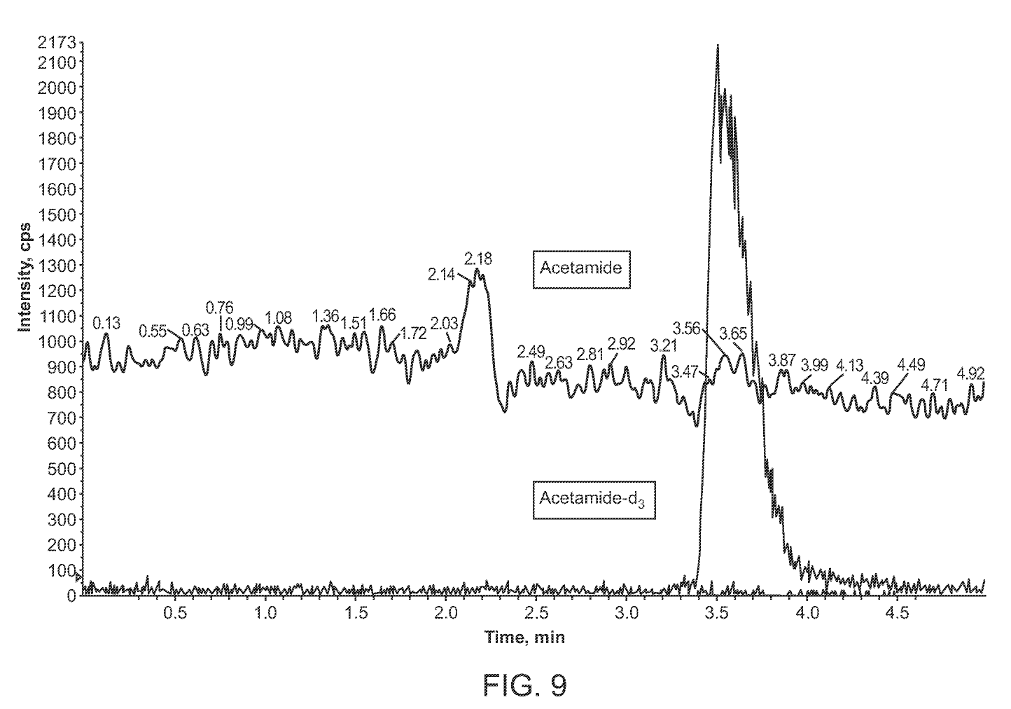

FIG. 6 is a chromatogram of an extract of Compound I with Acetamide spiked at 1.0 μg/g for validation of accuracy. FIG. 7 is a chromatogram of an extract of Compound I with Acetamide spiked at 0.75 μg/g for validation of accuracy. FIG. 8 is a chromatogram of an extract of Compound I with Acetamide spiked at 1.25 μg/g for validation of accuracy. FIG. 9 is a chromatogram of Compound I extract spiked with Acetamide-d₃ Internal Standard.

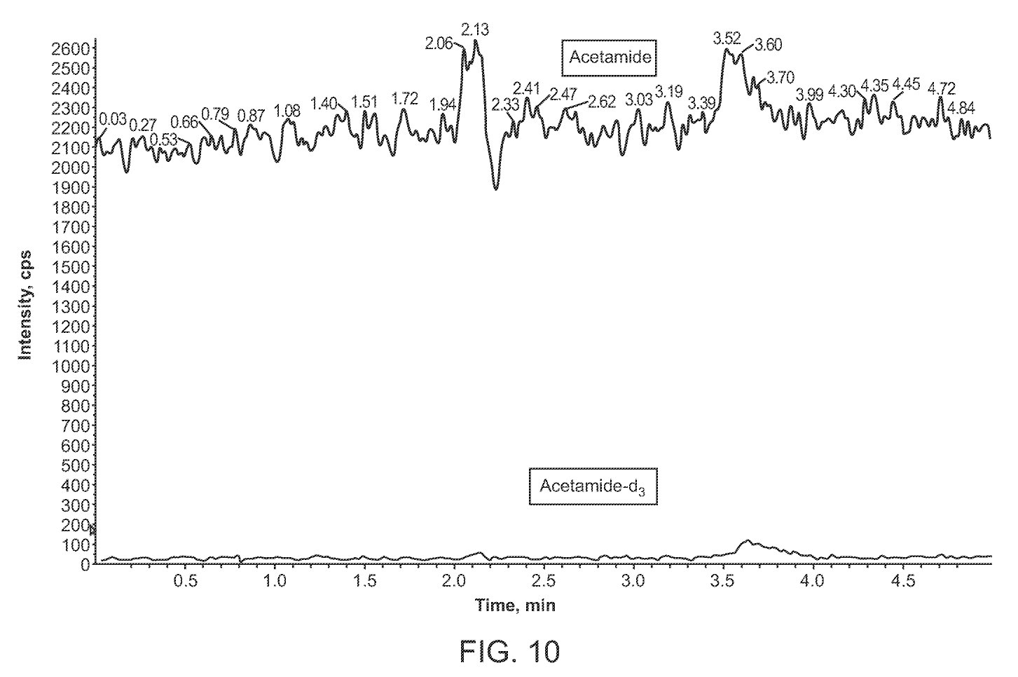

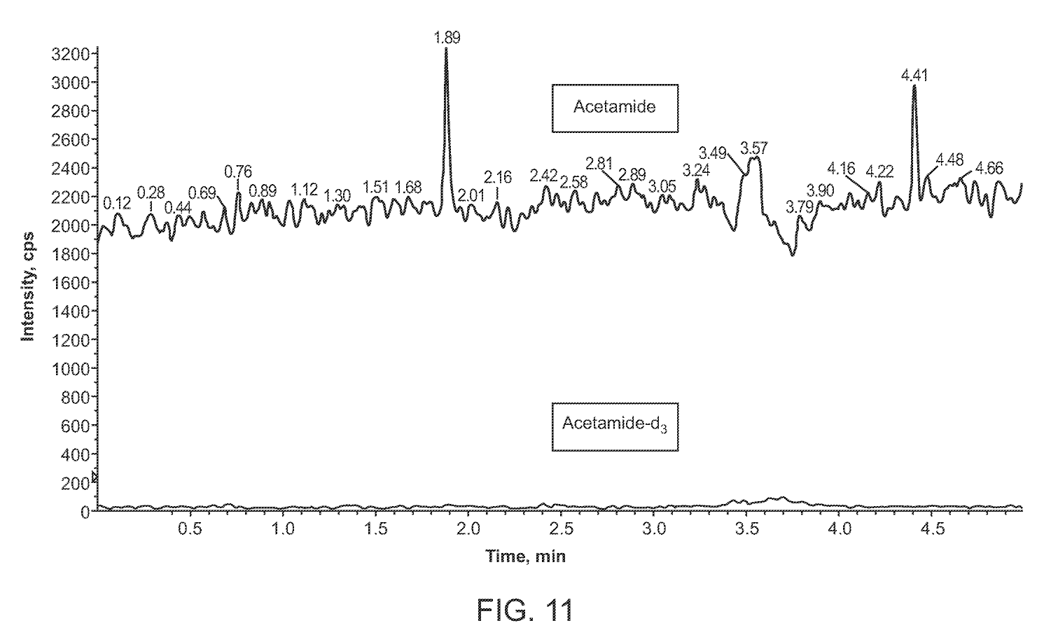

FIG. 10 is a chromatogram of an extract of Compound I only (endogenous control without Internal Standard Spike). FIG. 11 is a chromatogram of a Methanol Method Blank.

While the present invention is disclosed with reference to certain embodiments and examples detailed above, it is to be understood that these embodiments and examples are intended to be illustrative rather than limiting. As such, it is contemplated that various modifications and variations will be apparent to those skilled in the art and intended that those modifications and variations fall within the scope of the invention and the appended claims. All patents, patent applications, papers, and books cited in this application are incorporated by reference herein in their entirety.

What is claimed is:

1. A method for assaying a detectable amount of acetamide in a sample suspected of containing the acetamide, the method comprising:
(a) preparing a first composition suitable for chromatographic analysis wherein the first composition comprises the sample and a known detectable amount of acetamide-d₃;
(b) extracting any detectable acetamide together with the known detectable amount of acetamide-d₃ in the first composition by chromatography to provide for a second composition comprising acetamide-d₃ and any detectable acetamide contained in the sample; and
(c) assaying for the presence of the acetamide and the amount thereof, if present, in the second composition by passing a portion of the second composition through a mass spectrometer wherein the presence of the acetamide is confirmed by its molecular ion peak and the amount of the acetamide is determined by a comparison of the intensity of the peak generated by the acetamide to the intensity of the peak generated for the known amount of acetamide-d₃.

2. A method for assaying a detectable amount of acetamide in a sample suspected of containing the acetamide, the method comprising:
(a) preparing a first composition suitable for chromatographic analysis wherein the first composition comprises the sample;
(b) extracting any detectable acetamide in the first composition by chromatography to provide for a second composition comprising any detectable acetamide contained in the sample; and
(c) assaying for the presence of the acetamide and the amount thereof, if present, in the second composition by passing a portion of the second composition through a mass spectrometer, wherein the presence of the acetamide is confirmed by its molecular ion peak and the amount of the acetamide is determined by a comparison of the intensity of that peak to a concentration curve.

3. A method for assaying a detectable amount of acetamide in a sample suspected of containing the acetamide, the method comprising:
(a) generating a curve which correlates an intensity of a mass spectrum peak to a known concentration of acetamide;
(b) preparing a first composition suitable for chromatographic analysis wherein the first composition comprises the sample;
(c) extracting any detectable acetamide in the first composition by chromatography to provide for a second composition comprising any detectable acetamide contained in the sample; and
(d) assaying for the presence of the acetamide and the amount thereof, if present, in the second composition by passing a portion of the second composition through a mass spectrometer, wherein the presence of the acetamide is confirmed by its molecular ion peak and the amount of the acetamide is determined by a comparison of the intensity of that peak to the concentration curve prepared in (a) above.

4. The method of any of claim 1, 2, or 3, wherein the detectable amount of the acetamide in the sample is less than about 500 ppm.

5. The method of any of claim 1, 2, or 3, wherein the detectable amount of the acetamide in the sample is from about 0.01 ppm to about 50 ppm.

6. The method of claim 1, wherein the step (a) for preparing the composition of the sample comprises:
(i) dissolving a weighed amount of the sample in a measured amount of acetamide-d₃ diluent to prepare first sample solution; and
(ii) dissolving a weighed amount of the sample in a measured amount of standard preparation to prepare a second sample solution wherein the standard preparation comprises a measured amount of the acetamide solution mixed with a measured amount of the acetamide-d₃ solution.

7. The method of claim 1, wherein the chromatography in step (b) comprises a solid phase extraction cartridge that results in a retention of at least a portion of the sample in the cartridge while the acetamide is eluted in the second composition.

8. The method of claim 1, wherein the step (c) comprises an analysis by HPLC/MS/MS using multiple reaction monitoring (MRM) mode.

9. The method of claim 7, wherein the MRM mode comprises a monitoring of one or more fragment ions produced by a loss of ammonia from protonated molecular ions of unlabelled acetamide and d₃-labeled acetamide.

10. A composition comprising a sample suspected of containing an acetamide and a known amount of acetamide-d₃ wherein the acetamide is at a concentration of less than 500 ppm.

11. The composition of claim 10, wherein the concentration of the acetamide and the acetamide-d₃ is altered relative to their initial concentration.

12. The composition of claim 10, wherein the concentration of the acetamide is less than about 200 ppm in the sample.

13. The composition of claim 10, wherein the concentration of the acetamide is from about 0.01 ppm to about 50 ppm in the sample.
